(19) United States
(12) Patent Application Publication
(10) Pub. No.: US 2007/0138747 A1
(43) Pub. Date: Jun. 21, 2007

(54) MULTI-STAGE FERROFLUIDIC SEAL HAVING ONE OR MORE SPACE-OCCUPYING ANNULUS ASSEMBLIES SITUATED WITHIN ITS INTERSTAGE SPACES FOR REDUCING THE GAS LOAD THEREIN

(75) Inventors: Paul Michael Ratzmann, Germantown, WI (US); Aniruddha Dattatraya Gadre, Rexford, NY (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/306,077

(22) Filed: Dec. 15, 2005

(51) Int. Cl. F16J 15/43

(52) U.S. Cl. 277/302

(57) ABSTRACT

A multi-stage ferrofluidic seal, utile for substantially forming a hermetic seal about a rotatable shaft extending through an annular pole piece, is disclosed herein. The multi-stage ferrofluidic seal includes: a plurality of annular ridges defined and spaced apart on one or both of the outer surface of the shaft and the inner surface of the pole piece so that the shaft is situated in close proximity with the pole piece by means of the annular ridges; a plurality of annular ferrofluidic seals respectively formed on the tops of the annular ridges so as to substantially seal close-proximity gaps between the shaft and the pole piece; and at least one annulus respectively situated in at least one of the spaces between the annular ridges so as to encircle the shaft, wherein each annulus serves to occupy space within the multi-stage ferrofluidic seal so as to reduce the gas load therein.

### FIELD OF THE INVENTION

The present invention generally relates to ferrofluidic seals and more particularly relates to multi-stage ferrofluidic seals that are useful for forming hermetic seals about rotatable shafts.

### BACKGROUND OF THE INVENTION

During operation of a computed-tomography (CT) imaging system, a subject or patient is laid upon an elongated patient table, and the table is moved along a gantry axis by an electric motor so as to position a particular anatomical section or region of interest (ROI) within the patient underneath an x-ray tube. Once the patient is aligned underneath the x-ray tube as desired, movement of the patient table is then arrested so as to immobilize both the table and the patient. After the table and patient are immobilized, an annular gantry that encircles the patient and on which the x-ray tube is mounted is activated. Upon such activation, the gantry thereby proceeds to rotate or spin about the patient lying on the table. As the gantry spins, the x-ray tube mounted thereon emits a fan-shaped beam of x-rays toward the patient. In this way, the patient's ROI is thoroughly irradiated with x-rays from many different angles. As the x-rays attempt to pass through the patient during such irradiation, the x-rays are individually absorbed or attenuated (i.e., weakened) at various differing levels depending on the particular biological tissues existing within the ROI. These differing levels of x-ray absorption or attenuation are sensed and detected by an arcuate x-ray detector that is also mounted on the gantry and situated opposite the x-ray tube thereon. Based on these differing levels as detected, the CT imaging system then generates x-ray strength profiles and therefrom “constructs” digital images of the patient's ROI with the help of data-processing computers. Upon constructing such images, the images are then visibly displayed on a computer monitor so that a doctor or other medical professional can indirectly observe and examine the ROI within the patient. After conducting such an examination, the doctor can then accurately diagnose a patient's malady and prescribe an appropriate treatment.

During such operation, to facilitate fast revolutions of the x-ray tube mounted on the gantry while at the same maintain overall mechanical and operational stability of the CT imaging system itself, the overall weight of the x-ray tube system must generally be reduced so as to minimize any destabilizing g-forces associated with the x-ray tube system during rotation on the gantry. One way to reduce the overall weight of such an x-ray tube system is to minimize the amount of pump system equipment on the x-ray tube system that is necessary to evacuate gas or air from the x-ray tube for sustaining a vacuum therein, for such pump system equipment is typically quite bulky. To help reduce the necessary amount of pump system equipment on such an x-ray tube system, the multi-stage ferrofluidic seal system that conventionally encircles the x-ray tube's anode-rotating shaft for helping seal and maintain a vacuum within the x-ray tube should be designed to reduce the frequency of any bursting of the individual annular ferrofluidic seals (i.e., fluid rings) within the seal system. In this way, the x-ray tube system's pump system need only have the physical capacity for mere infrequent to intermittent pumping instead of very frequent to continuous pumping. To reduce the frequency of individual fluid rings bursting within such a ferrofluidic seal system, however, the seal system must generally be designed so as to reduce or minimize the gas or pressure loads on its individual fluid rings whenever the seal system experiences a significant difference in pressure between the two regions on opposite sides of the seal system.

In view of the above, there is a present need in the art for a multi-stage ferrofluidic seal system that is designed to minimize the gas or pressure loads on its individual annular ferrofluidic seals whenever the seal system experiences a significant difference in pressure between the two regions on opposite sides of the seal system.

### SUMMARY OF THE INVENTION

The present invention provides a multi-stage ferrofluidic seal system for substantially forming a hermetic seal about a rotatable shaft that extends through an opening in a partition between two regions or environments. In one practicable embodiment, the multi-stage ferrofluidic seal system includes a cylindrical permanent magnet, an annular first pole piece, an annular second pole piece, a plurality of annular ridges, a plurality of annular ferrofluidic seals, and at least one annulus. The cylindrical permanent magnet, first of all, is substantially hollow and has both a first end with a north-seeking pole and an opposite second end with a south-seeking pole. As such, the cylindrical permanent magnet is mounted within the partition opening so as to encircle the shaft. In addition thereto, the annular first pole piece is mounted within the partition opening so as to encircle the shaft as well and also substantially abut the first end of the permanent magnet. The annular second pole piece, on the other hand, is mounted within the partition opening so as to encircle the shaft and substantially abut the second end of the permanent magnet. Moreover, the annular ridges are defined and spaced apart on at least one of the outer surface of the shaft, the inner surface of the first pole piece, and the inner surface of the second pole piece so that the shaft is situated in close proximity with one or both of the first pole piece and the second pole piece by means of the annular ridges. The annular ferrofluidic seals, in turn, are respectively formed on the tops of the annular ridges so as to substantially seal close-proximity gaps between the shaft and one or both of the first pole piece and the second pole piece. Furthermore, each annulus is respectively situated in one of the spaces between the annular ridges so as to encircle the shaft. In such a configuration, each annulus serves to occupy space within the multi-stage ferrofluidic seal system so as to reduce the gas load therein.

Moreover, the present invention also provides a multi-stage ferrofluidic seal for substantially forming a hermetic seal about a rotatable shaft extending through an annular pole piece. In one practicable embodiment, the multi-stage ferrofluidic seal includes a plurality of annular ridges, a plurality of annular ferrofluidic seals, and at least one annulus. The annular ridges, first of all, are defined and spaced apart on one or both of the outer surface of the shaft and the inner surface of the pole piece so that the shaft is situated in close proximity with the pole piece by means of the annular ridges. The annular ferrofluidic seals, in turn, are respectively formed on the tops of the annular ridges so as to substantially seal close-proximity gaps between the shaft and the pole piece. Furthermore, each annulus is respectively situated in one of the spaces between the annular ridges so as to encircle the shaft. In such a configuration, each annulus serves to occupy space within the multi-stage ferrofluidic seal so as to reduce the gas load therein.

Furthermore, the present invention also provides an annulus assembly for occupying interstage space and thereby reducing the gas load within a multi-stage ferrofluidic seal that substantially forms a hermetic seal about a rotatable shaft. In one practicable embodiment, the annulus assembly includes a first arcuate section, a second arcuate section, a first connector, and a second connector. The first arcuate section has a first end and a second end, and the second arcuate section has a first end and a second end as well. The first connector is adapted for connecting the first end of the first arcuate section to the second end of the second arcuate section. The second connector, on the other hand, is adapted for connecting the second end of the first arcuate section to the first end of the second arcuate section. Adapted as such, the first connector and the second connector are utile for connecting the first arcuate section and the second arcuate section together so that the first arcuate section and the second arcuate section cooperatively encircle the rotatable shaft.

Lastly, in addition to the above, it is believed that various alternative embodiments, design considerations, applications, methodologies, and advantages of the present invention will become apparent to those skilled in the art when the detailed description of the best mode contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a plan view of an x-ray system.

FIG. 2A illustrates a sectional side view of the x-ray system depicted in FIG. 1. In this view, the x-ray system is shown to include an x-ray tube having both an anode assembly and a cathode assembly situated therein.

FIG. 2B illustrates a system diagram of the x-ray tube depicted in FIG. 2A. In this diagram, the anode assembly within the x-ray tube is shown to be mounted on a rotatable shaft, which is extended into the x-ray tube via a ferrofluidic seal system so as to substantially keep the x-ray tube hermetically sealed.

FIG. 3 illustrates a sectional view of a multi-stage ferrofluidic seal system that is largely conventional. As shown in this view, the multi-stage ferrofluidic seal system substantially forms a hermetic seal about a rotatable shaft, which extends through an opening in a partition that separates two regions or environments.

FIG. 4A illustrates a sectional view of one stage within the multi-stage ferrofluidic seal system depicted in FIG. 3. In this view, the stage is shown to include an annular ferrofluidic seal formed in a close-proximity gap between the inner surface of an annular pole piece and the top of an annular ridge defined on the outer surface of the rotatable shaft.

FIG. 4B illustrates a sectional view of the one ferrofluidic seal system stage depicted in FIG. 4A. In this view, the position of the annular ferrofluidic seal is slightly shifted because of a disparity between the respective environmental pressures in the two regions that are on opposite sides of the ferrofluidic seal.

FIG. 4C illustrates another sectional view of the one ferrofluidic seal system stage depicted in FIG. 4A. In this view, the disparity between the respective environmental pressures in the two regions on opposite sides of the annular ferrofluidic seal is significant enough that the ferrofluidic seal bursts and leaks air or gas through the close-proximity gap between the pole piece and the rotatable shaft.

FIG. 5A illustrates a perspective view of a computed tomography (CT) imaging system, which is shown to include a rotatable gantry with an x-ray tube mounted thereon.

FIG. 5B illustrates a perspective view of the rotatable gantry depicted in FIG. 5A. In this view, operation of the x-ray tube on the gantry is highlighted.

FIG. 6 illustrates a sectional view of one practicable embodiment of a multi-stage ferrofluidic seal system according to the present invention. As shown in this view, the multi-stage ferrofluidic seal system substantially forms a hermetic seal about a rotatable shaft, which extends through an opening in a partition that separates two regions or environments. As also shown in this view, the multi-stage ferrofluidic seal system includes a plurality of annuluses or annulus assemblies that occupy interstage spaces within the system for thereby reducing the gas load within the system.

FIG. 7A illustrates a sectional view of one practicable embodiment of a multi-stage ferrofluidic seal according to the present invention. As shown in this view, the multi-stage ferrofluidic seal substantially forms a hermetic seal about a rotatable shaft that extends through an annular pole piece. As also shown in this view, the multi-stage ferrofluidic seal includes a plurality of annuluses or annulus assemblies that occupy interstage spaces within the seal for thereby reducing the gas load within the seal.

FIG. 7B illustrates a sectional profile of one of the annuluses or annulus assemblies depicted in FIG. 6 or FIG. 7A.

FIG. 8A illustrates a plan view of a practicable embodiment of one of the annulus assemblies depicted in FIG. 6 or FIG. 7A. In this view, the annulus assembly is shown fully assembled.

FIG. 8B illustrates a plan view of the annulus assembly depicted in FIG. 8A. In this view, the annulus assembly is shown disassembled.

FIG. 9A illustrates a plan view of another practicable embodiment of one of the annulus assemblies depicted in FIG. 6 or FIG. 7A. In this view, the annulus assembly is shown fully assembled.

FIG. 9B illustrates a plan view of the annulus assembly depicted in FIG. 9A. In this view, the annulus assembly is shown disassembled.

FIG. 10 illustrates a longitudinal view of the rotatable shaft and annuluses or annulus assemblies depicted in FIG. 6. In this view, the shaft is shown to include annular ridges that are defined and spaced apart on the outer surface of the shaft, and the annuluses or annulus assemblies are shown situated between the annular ridges so as to encircle the shaft at various points along its length.

### DETAILED DESCRIPTION OF THE INVENTION

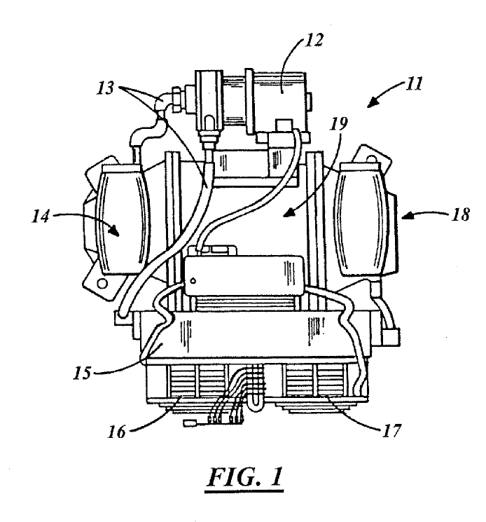

FIG. 1 illustrates a plan (i.e., top) view of a largely conventional x-ray system 11. As shown, the x-ray system 11 generally includes an anode end 14, a cathode end 18, and a center section 19. The center section 19 is situated between both the anode end 14 and the cathode end 18 and contains an x-ray tube 20 that serves to generate x-rays.

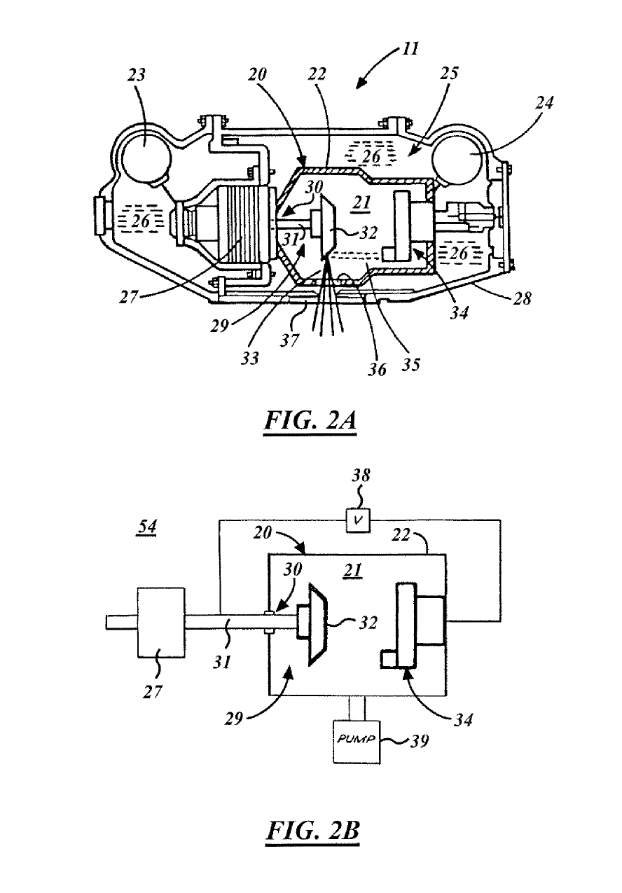

FIG. 2A illustrates a sectional side view of the x-ray system 11 depicted in FIG. 1. As shown in FIG. 2A, the x-ray tube 20 in the system 11 largely includes a vacuum vessel 22 that is situated in a chamber 25 defined within a casing 28. The vacuum vessel 22 is constructed to endure very high temperatures and includes x-ray transmissive materials such as, for example, glass or Pyrex, and may even include sections of non-transmissive materials such as stainless steel or copper. The casing 28, on the other hand, may include, for example, aluminum and may also be lined with lead to block the passage of x-rays therethrough. Per convention, the chamber 25 within the casing 28 is filled with a heat-absorbing cooling fluid 26 such as, for example, a dielectric oil. During operation of the x-ray system 11, wherein high temperatures are generated in the x-ray tube 20, the cooling fluid 26 is circulated through the system 11 to thereby absorb thermal energy (i.e., heat) from the tube 20 so as to cool the tube 20 and prevent damage thereto. Furthermore, in addition to absorbing heat from the x-ray tube 20, the cooling fluid 26 also serves to electrically insulate the casing 28 from high-voltage electrical charges existing within the tube's vacuum vessel 22.

To circulate the cooling fluid 26 through the x-ray system 11, the system's center section 19, as shown in FIG. 1, has a pump 12 mounted to one side. Mounted as such, the pump 12 is operable to circulate the cooling fluid 26 throughout the x-ray system 11 via a series of fluid hoses 13. To remove absorbed heat from the cooling fluid 26 before the fluid 26 is recirculated through the x-ray system 11 to further cool the tube 20, the system's center section 19 also has an in-line radiator 15 mounted to another side. The radiator 15 has associated cooling fans 16 and 17 operatively mounted thereto for creating a cooling air flow over the radiator 15. In this configuration, any heat absorbed by the cooling fluid 26 is thus largely dissipated by circulating the fluid 26 through the radiator 15.

As further illustrated in FIG. 2A, the x-ray system 11 also includes both an anode receptacle 23 and a cathode receptacle 24 that serve as points of connection for electrically energizing the x-ray system 11. Correspondingly, the x-ray tube 20 within the x-ray system 11 includes both an anode assembly 29 in electrical communication with the anode receptacle 23 and a cathode assembly 34 in electrical communication with the cathode receptacle 24. The anode assembly 29 and the cathode assembly 34, in general, are situated in a largely evacuated chamber region 21 defined within the vacuum vessel 22. The anode assembly 29, in particular, includes a beveled disc 32 mounted on one end of a rotatable shaft 31 that extends into the chamber region 21 within the vacuum vessel 22. The cathode assembly 34, on the other hand, includes both a focusing cup and an energizable filament (not particularly shown) situated opposite the disc 32 in the chamber region 21 within the vessel 22. Outside the vacuum vessel 22, the x-ray system 11 further includes a driving induction motor 27 in mechanical communication with the other end of the rotatable shaft 31.

During operation, when the x-ray system 11 is energized by an electrical power supply 38 electrically connected between the anode receptacle 23 and the cathode receptacle 24, a focused stream of electrons 35 is emitted from the filament of the cathode assembly 34 and directed toward the disc 32 of the anode assembly 29. As the electron stream 35 impinges on the surface of the disc 32, the driving induction motor 27 operates to rotate the shaft 31 and disc 32 together at a very high rate of angular speed. In this way, as electrons from the directed electron stream 35 are absorbed and/or deflected at the surface of the rotating disc 32, high-frequency electromagnetic waves or x-rays 33 are thereby produced. In addition to producing such x-rays 33, this same operation, as briefly alluded to hereinabove, also generates large amounts of heat within the vacuum vessel 22 of the x-ray tube 20.

As shown in FIG. 2A, the x-rays 33 emanating from the disc 32 pass both through the chamber region 21 of the vacuum vessel 22 and out of the vessel 22 by way of an x-ray transmissive window 36 in the wall of the vessel 22. Thereafter, the x-rays 33 pass through the cooling fluid 26 between the x-ray tube 20 and the casing 28 and then ultimately through another window 37 formed in the wall of the casing 28. As is the inner window 36, the outer window 37 is also x-ray transmissive and may comprise, for example, beryllium. As shown in FIG. 2A, the outer transmissive window 37 is particularly situated in the wall of the casing 28 so as to generally be aligned with the inner transmissive window 36 in the wall of the vacuum vessel 22. With both windows 36 and 37 aligned as such, the x-ray system 11 as a whole can thus be oriented so as to directionally focus the x-rays 33 toward a subject or patient 56 for irradiation and imaging purposes.

FIG. 2B illustrates a system diagram of the x-ray tube 20 depicted in FIG. 2A. In this diagram, the rotatable shaft 31 associated with the anode assembly 29 of the x-ray tube 20 is highlighted. As shown, the shaft 31 extends into the chamber region 21 of the tube's vacuum vessel 22 via a ferrofluidic seal system 30 so as to substantially keep the x-ray tube 20 hermetically sealed. By keeping the x-ray tube 20 hermetically sealed, the ferrofluidic seal system 30 thereby helps sustain a substantial vacuum in the chamber region 21 within the tube's vacuum vessel 22. With such a vacuum in the tube's vessel 22, electrons emitted from the cathode assembly 34 during operation are freely directed toward the anode assembly's disc 32 without their colliding with extraneous (i.e., interfering) gas or air molecules in the vessel's chamber region 21. Furthermore, in addition to helping keep out extraneous gas or air, the ferrofluidic seal system 30 also serves to keep out particulates and other contaminants that may potentially be introduced into the vacuum vessel 22 of the x-ray tube 20. To help the ferrofluidic seal system 30 maintain a substantial vacuum within the tube's vacuum vessel 22, any excessive amount of extraneous gas or air that is inadvertently introduced into the chamber region 21 of the vessel 22 is largely evacuated by means of a pump system 39. The pump system 39, in general, is activated as necessary by a gauge (not shown) that monitors the pressure within the tube's vessel 22.

As their name implies, ferrofluidic seals generally operate by employing and situating a ferrofluid in a gap between the outer surface of a rotating shaft and one or more proximal surrounding surfaces. In general, a “ferrofluid” is a magnetic type fluid that includes a highly stable colloidal dispersion of approximately 10-nanometer sized magnetic particles in a carrier liquid. By design, the magnetic particles are sufficiently small so that they are prevented from settling in gravitational or magnetic fields by thermal motion. A surface coating of adsorbed surfactant(s) or electric charges on the particles themselves helps prevent agglomeration of the particles to each other so that their associated colloids are stable over long periods of time.

Comprising such, a ferrofluid is responsive to magnetic fields and may thus be shaped and formed to create a gas-tight seal. In a conventional ferrofluidic seal, for example, a ferrofluid may be formed as a sealing o-ring and retained in an annular-shaped gap, such as in a gap that surrounds a cylindrical rotating shaft, by a carefully designed magnetic field that is created in and/or about the gap. When formed and retained as such, the ferrofluid effectively serves as a barrier to the passage of gas or air along the outer surface of the shaft while at the same time permitting rapid rotation of the shaft as desired. In general, for a given magnetic field established in an annular-shaped gap, the maximum pressure differential across an annular-shaped ferrofluidic seal in the gap that can be supported or endured by the seal without the seal breaking apart or “bursting” is largely determined by the intensity of the magnetic field that is sustained in the gap and also the concentration of magnetic particles within the seal's own ferrofluid.

To create and sustain a ferrofluid-retaining magnetic field in a gap about a shaft, a conventional ferrofluidic seal system includes a magnet and two pole pieces. Typically, the magnet is an annular, or hollow cylindrical, permanent type magnet that is polarized axially. Per convention, the magnet is positioned about the shaft so as to encircle the shaft without physically touching the shaft. The two pole pieces, in turn, are typically annular as well and generally comprise magnetically permeable material. As such, the two pole pieces sandwich (i.e., abut) the magnet at the magnet's two pole ends so that the inner surfaces of the annular-shaped pole pieces respectively both face and encircle the outer surface of the shaft, thereby forming (i.e., defining) a close-proximity annular-shaped gap about the shaft. In such a configuration, the magnet is able to establish a desired magnetic flux path both in and about the shaft for thereby concentrating and retaining ferrofluid in a seal-tight manner in the annular gap about the shaft. Though such a conventional ferrofluidic seal is most often installed and utilized so as to remain stationary about the outer surface (i.e., periphery) of a rotating shaft, such a seal may also be installed and utilized to seal the outer surface of a stationary shaft about which a hub rotates.

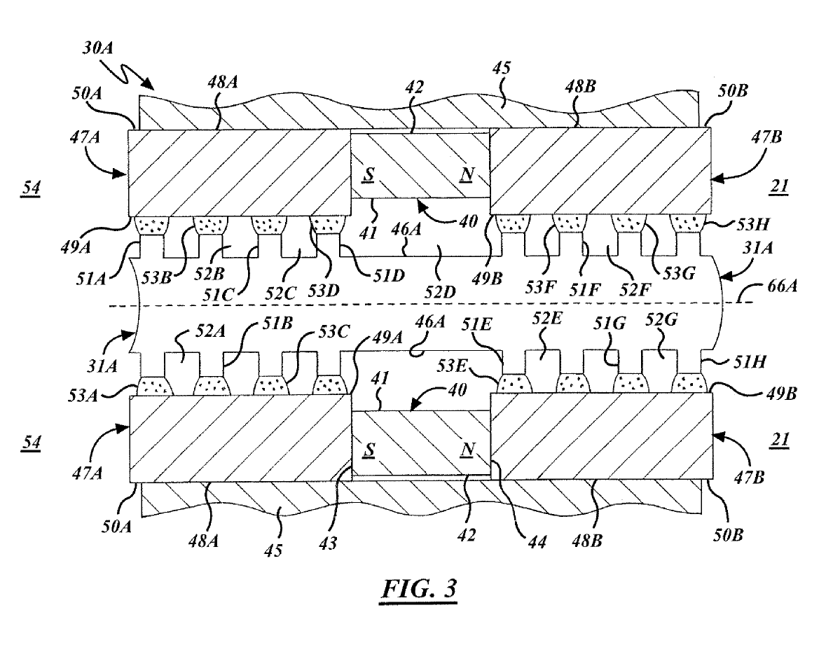

FIG. 3 illustrates, as an example, a sectional view of a multi-stage ferrofluidic seal system 30A that is largely conventional. In general, the ferrofluidic seal system 30A serves to substantially form a hermetic seal about a rotatable shaft 31A that extends through a hole or opening in a partition 45 between two environments or regions 21 and 54. As shown, the multi-stage ferrofluidic seal system 30A includes a cylindrical permanent magnet 40, an annular first pole piece 47B, an annular second pole piece 47A, a plurality of annular ridges 51A-51H, and a plurality of annular ferrofluidic seals 53A-53H. The cylindrical permanent magnet 40, first of all, is substantially hollow and has both a first end 44 with a north-seeking pole N and an opposite second end 43 with a south-seeking pole S. As such, the cylindrical permanent magnet 40 is mounted within the partition opening so as to encircle the shaft 31A. In addition thereto, the annular first pole piece 47B is mounted within the partition opening so as to encircle the shaft 31A as well and also substantially abut the first end 44 of the permanent magnet 40. The annular second pole piece 47A, on the other hand, is mounted within the partition opening so as to encircle the shaft 31A and substantially abut the second end 43 of the permanent magnet 40. Moreover, the annular ridges 51A-51H are defined and spaced apart on the outer surface 46A of the shaft 31A so that the shaft 31A is situated in close proximity with both the first pole piece 47B and the second pole piece 47A by means of the annular ridges 51A-51H. The annular ferrofluidic seals 53A-53H, in turn, are respectively formed on the tops of the annular ridges 51A-51H so as to substantially seal close-proximity gaps between the shaft 31A and both the first pole piece 47B and the second pole piece 47A. Lastly, though omitted for the sake of simplicity and clarity in FIG. 3, the ferrofluidic seal system 30A may also include various shaft-supporting bearings, static seals, retaining structures, et cetera, for such elements are frequently part of a total seal package.

In the ferrofluidic seal system 30A as configured in FIG. 3, magnetic lines of flux (not shown) are created which circulate through a “magnetic circuit” generally defined through the system magnet's north-seeking pole N, the first pole piece 47B, the ferrofluidic seals 53E-53H, the ridges 51E-51H on the shaft 31A, the length of the shaft 31A, the ridges 51A-51D on the shaft 31A, the ferrofluidic seals 53A-53D, the second pole piece 47A, and the system magnet's south-seeking pole S. With the intensity of the magnetic flux lines concentrating highly within the ridges 51A-51H, the volume of ferrofluid between the shaft 31A and the two pole pieces 47A and 47B is separated and retained in the discrete ferrofluidic o-ring type seals 53A-53H which encircle the shaft 31A and physically bridge the close-proximity gaps defined between the tops of the shaft's ridges 51A-51H and the inner surfaces 49A and 49B of the pole pieces 47A and 47B. In this way, the annular ferrofluidic seals 53A-53H help prevent the flow of gas or air under pressure, for example, from a high-pressure region 54, through the seal system 30A, and to a low-pressure region 21.

In a ferrofluidic seal system, the intensity of a magnetic field existing in the gap(s) surrounding a shaft is largely determined by the particular configuration of the magnetic circuit that generates the field. In addition, the intensity of the magnetic field existing in the gap(s) also depends on the magnetomotive force of the system magnet as well as the magnetic reluctance of the various elements that make up the overall magnetic circuit. In a conventional ferrofluidic seal system, the magnetic circuit set up therein typically forms multiple discrete ferrofluidic seals within the seal system by establishing and sustaining a constant magnetic field in the gap(s) about the shaft.

Per convention, a single annular ferrofluidic seal 53 formed and retained on top of an annular ridge 51 within the ferrofluidic seal system 30A is referred to as a seal “stage.” As shown in FIG. 3, multiple seal stages within the ferrofluidic seal system 30A are separated and defined by open spaces 52A-52G, which are conventionally referred to as “interstage” regions or spaces. Such interstage spaces may contain various amounts of gas or air, or even be substantially evacuated. In one common variation of such a conventional ferrofluidic seal system 30A, the annular ridges 51A-51H may alternatively be defined so as to be recessed within the outer surface 46A of the shaft 31A rather than protruding from its outer surface 46A. In another possible variation, the ridges 51A-51H, instead of being defined on the shaft 31A, may alternatively be defined on the inner surfaces 49A and 49B of the pole pieces 47A and 47B, either in a recessed or a protruding fashion. In addition, the annular ridges 51A-51H themselves, instead of having rectangular cross-sections, may alternatively take on various other cross-sectional shapes as well. Furthermore, instead of incorporating and employing only the one system magnet 40, the ferrofluidic seal system 30A may alternatively incorporate and employ multiple system magnets.

In general, a single-stage ferrofluidic seal system can be simply created by situating a single annular pole piece both around a shaft and in close proximity therewith so as to be in magnetic communication with one pole of a single system magnet. Within such a configuration, ferrofluid can be retained in the gap, particularly between the shaft and the encircling annular pole piece, by the magnetic field that is created by the system magnet. The magnetic field itself follows a magnetic circuit that initially includes the system magnet, the pole piece, the ferrofluid-bridged gap, and the shaft. To help complete the magnetic circuit, the ferrofluidic seal system may further include a second annular pole piece, which is situated both around the shaft and in close proximity therewith so as to be in magnetic communication with the other pole of the system magnet. In such a ferrofluidic seal system, the gap particularly between the second pole piece and the shaft generally retains no ferrofluid for sealing, but it does help enhance the magnetic flux across the gap particularly between the first pole piece and the shaft. With such enhancement of the flux between the first pole piece and the shaft, the ferrofluid is retained therebetween in a seal-tight manner so as to form a single-stage seal, thus enabling the overall seal system to endure large pressure loads without prematurely breaking apart or bursting.

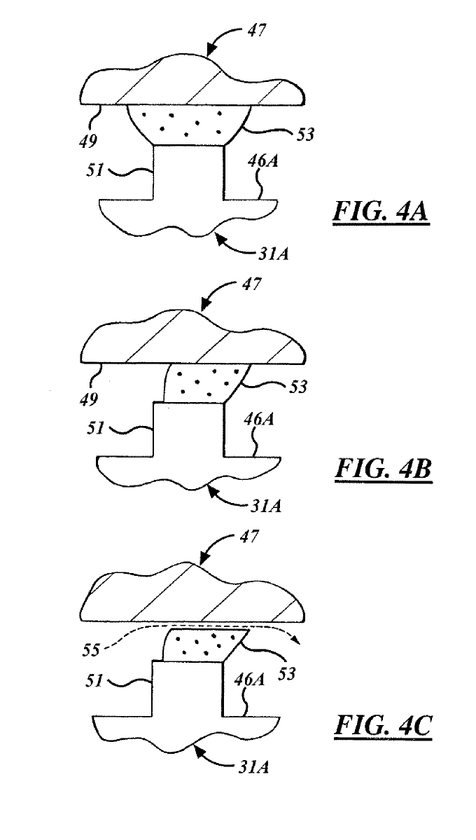

In general, a single annular ferrofluidic seal (i.e., a fluid ring) within one stage of a ferrofluidic seal system can only withstand a certain limited amount of pressure or pressure load. Thus, should the pressure differential between the two regions or spaces on opposite sides of the single annular ferrofluidic seal ever become greater than the seal system magnet's strength and ability to sustain the single annular seal, the single seal or fluid ring will (at least temporarily) burst. When such a single annular ferrofluidic seal bursts, a leakage path is created through the fluid ring that allows gas and/or air to pass by the seal. For purposes of illustration, such a bursting event is shown and highlighted in FIGS. 4A-4C. As first shown in FIG. 4A, with no significant pressure differential existing between the two regions or spaces on opposite sides of the single annular ferrofluidic seal 53, the ring's body of fluid is symmetrically retained in position, thereby bridging the close-proximity gap between the inner surface 49 of a pole piece 47 and an annular ridge 51 on the shaft 31A in a seal-tight manner. As next shown in FIG. 4B, however, when a somewhat significant pressure differential is applied across the single annular ferrofluidic seal 53, the body of fluid retained in the ring 53 is shifted and displaced toward the ring's low-pressure side. Lastly, as shown in FIG. 4C, when the pressure differential applied across the single annular ferrofluidic seal 53 is excessive, the body of fluid in the ring 53 is apt to give way and burst. When the single annular ferrofluidic seal 53 bursts in this manner, a leakage path 55 is created through the single annular seal 53 that permits gas or air to pass by the seal 53.

To ensure that a ferrofluidic seal system intended for withstanding high-pressure loads remains substantially seal-tight overall even if a single annular ferrofluidic seal therein happens to burst, a conventional ferrofluidic seal system is typically equipped with multiple stages of annular ferrofluidic seals. To successfully implement multiple stages of seals, a conventional ferrofluidic seal system may include multiple annular ridges defined on the outer surface of its associated shaft, as does the seal system 30A in FIG. 3. In other possible embodiments, a ferrofluidic seal system, instead of having ridges on its shaft, may alternatively include either a series of multiple discrete annular pole pieces, or merely one or two annular pole pieces that have multiple annular ridges and grooves defined on its/their inner surface(s). In any one such embodiment of a conventional ferrofluidic seal system, the inner diameters, outer diameters, widths, and geometric shapes of its annular pole pieces generally need not be uniform. In addition, the heights, widths, and geometric shapes of its annular ridges, whether defined on the shaft or pole pieces, generally need not be uniform either.

For best withstanding high-pressure loads, a multi-stage ferrofluidic seal system is designed so that multiple fluid rings respectively encircle its associated shaft at various points along the shaft's length. In this way, multiple stages of fluid rings are thereby created and arranged in series longitudinally on the shaft. In such a configuration, when the multi-stage ferrofluidic seal system is initially exposed to a pressure differential that exists between the two regions or spaces on opposite sides of the overall ferrofluidic seal system, one of the outer fluid rings (i.e., stages) in the seal system may particularly experience a very large individual pressure load. As a result, such an outer fluid ring may temporarily burst and thus permit the passage of gas or air therethrough, thereby passing on and redistributing extra pressure to a second fluid ring situated in an adjacent or a next stage. If the pressure-holding capacity of that next stage is consequently exceeded as well, the fluid ring associated with that stage will then likewise burst and similarly permit the transfer of gas or air to a subsequent stage. In general, such bursting of individual fluid rings within a multi-stage ferrofluidic seal system will continue until the various pressure levels respectively existing in the spaces or regions in between and/or about the individual seal stages can be withstood by the individual fluid rings. Thus, once the various pressure levels respectively existing in the spaces or regions in between and/or about the individual seal stages are readjusted via such bursting so that the various pressure levels can be successfully withstood by the individual fluid rings, the magnetic field(s) for forming the individual fluid rings will help the fluid rings reseal themselves. In this way, pressure equilibrium is reestablished both within and about the multi-stage ferrofluidic seal system so that gas or air is largely prevented from passing through the overall seal system.

More particularly, after an individual fluid ring within one stage of a multi-stage ferrofluidic seal system bursts, the pressure differential across that seal stage is effectively reduced by the consequential passage of gas or air through that stage. When the pressure differential across the seal stage is sufficiently reduced in this manner, a system magnet's magnetic field will help the fluid ring both reform and reseal itself so that the sealing ability and integrity of that seal stage, as well as the overall seal system, is thereby restored. Thus, after an initial application of significant pressure across a multi-stage ferrofluidic seal system, the individual fluid rings respectively situated within the multiple seal stages of the overall seal system will soon thereafter reach pressure equilibrium with the spaces both in between and around them so that the individual fluid rings reseal themselves. Any individual fluid ring within a seal stage that does happen to burst in reaching such equilibrium, however, will subsequently exist and operate within the overall seal system generally near its burst condition. Thus, if a fluctuation in pressure across the ferrofluidic seal system later occurs such that the pressure differential across that same seal stage is consequentially increased, or if a condition develops that consequentially decreases the pressure-holding capacity of that same seal stage (for example, a mechanical, thermal, magnetic, or other problem), that same seal stage may burst again. Over time, if the individual fluid rings respectively situated within the multiple seal stages of a multi-stage ferrofluidic seal system are caused to burst numerous times, small volumes of gas or air may be passed from interstage space to interstage space within the seal system so that eventually small volumes of gas or air are inadvertently passed entirely through the overall seal system. Such passage of gas or air entirely through a ferrofluidic seal system is generally undesirable, especially when such a seal system is being utilized, for example, to help sustain a substantial vacuum in a chamber region within an x-ray tube's vacuum vessel as in FIGS. 2A and 2B.

In view of the operational nature and inherent limitations of such conventional multi-stage ferrofluidic seal systems, a modern ferrofluidic seal system employed to seal a high-vacuum system, either under static or dynamic conditions, is often designed to permit controlled periodic bursts of air to pass through the seal system and be introduced into the vacuum system. The periodicities of the bursts of air permitted by such a ferrofluidic seal system depend on the particular seal design and inherent operating characteristics of the seal system. For example, when such a modern ferrofluidic seal system is employed in operation and exposed to a pressure load for the first time after being in a static condition, a burst of air may initially be permitted to pass through the seal system and be introduced into its associated vacuum system. In such a ferrofluidic seal system wherein such controlled bursting is by design intended to periodically occur, its associated vacuum system, as a consequence, must generally be periodically or continuously evacuated by a supplemental pumping means, as is the x-ray tube 20 by pump system 39 in FIG. 2B. Such a periodic or continuous pumping means may, however, add significantly to a vacuum system's overall weight.

“Computer-assisted tomography” (CAT), also known as “computed tomography” (CT), is a method of medical imaging and diagnosis that utilizes x-rays generated by an x-ray system, such as the x-ray system 11 shown in FIGS. 1, 2A, and 2B. During operation of such an x-ray system 11, as briefly mentioned hereinabove, a stream (i.e., beam) of electrons 35 is fired toward an anode assembly's rotating disc 32 within a vacuum vessel's high-vacuum chamber region 21. During such operation, it is generally necessary to generate a large number of x-rays over a relatively short period of time, rather than a low number of x-rays over a longer period of time, for the former is better tolerated by human subjects or patients that are irradiated with such x-rays. To accomplish such, a high-power electron beam is utilized to bombard the anode assembly's rotating disc 32 so as to produce the x-rays 33. Such a process, however, as mentioned previously, generally results in the generation of high levels of heat and thus can cause radiation-induced degradation of the anode assembly's rotating disc 32. To help minimize such degradation, the shaft 31 on which the rotating disc 32 is mounted rotates very rapidly, for example, many thousands of revolutions per minute, so that a different anode surface area on the disc 32 is continuously presented to the electron beam 35. As the anode surface areas on the rotating disc 32 are continuously rotated out of the impinging electron beam's focus, the anode surface areas on the disc 32 are allowed sufficient time to cool before being re-introduced into the electron beam's focus, thereby minimizing degradation of the disc 32. Since such an x-ray system 11 within a CT imaging system (i.e., scanner) is typically mounted on a spinning annular gantry that violently accelerates and decelerates so as to rotate back and forth around each human patient to irradiate (i.e., scan) an anatomical region of interest (ROI) from various different angles in a short period of time, the overall weight of the x-ray system 11 is preferably made as low as possible. In this way, the total g-force of the x-ray system 11 as it rotates on the gantry is minimized, thereby helping to ensure mechanical and operational stability of the overall CT imaging system during operation. One desirable way to help reduce the overall weight of such an x-ray system 11 is to minimize or eliminate the necessity of frequent or continuous pumping by the bulky aforementioned pump system 39.

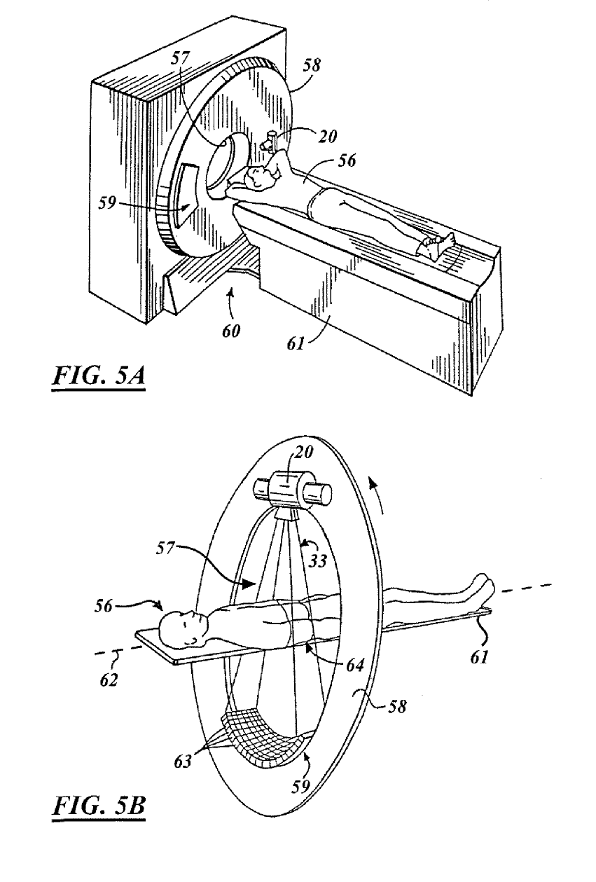

To illustrate how the x-ray system 11 is both mounted and incorporated in a CT imaging system, FIGS. 5A and 5B show perspective views highlighting some of the primary scanning elements in a largely conventional computed tomography (CT) imaging system 60. As shown, the CT imaging system 60 includes an elongated patient table 61, an annular gantry 58, an x-ray system tube 20, and an arcuate detector 59. In general, the patient table 61 is situated within an aperture or opening 57 defined within the gantry 58 so as to be collinearly aligned with an axis 62 defined through the center of the gantry's opening 57. As best shown in FIG. 5B, the x-ray tube 20 is mounted at or near a 12 o'clock position on the gantry 58, and the detector 59 is mounted at or near a 6 o'clock position on the gantry 58.

For operation of the CT imaging system 60 in FIGS. 5A and 5B, a subject or patient 56 is laid upon the patient table 61, and the table 61 is moved along the gantry axis 62 by an electric motor (not shown) so as to position a particular anatomical section or region of interest (ROI) 64 within the patient 56 underneath the x-ray tube 20. Once the patient 56 is aligned underneath the x-ray tube 20 as desired, movement of the patient table 61 is then arrested so as to immobilize both the table 61 and the patient 56. After the table 61 and patient 56 are immobilized, the gantry 58 is activated and thereby proceeds to rotate or spin about the patient 56 lying on the table 61. As the gantry 58 spins, the x-ray tube 20 emits a fan-shaped beam of x-rays 33 toward the patient 56. In this way, the patient's ROI 64 is thoroughly irradiated with x-rays 33 from many different angles. As the x-rays 33 attempt to pass through the patient 56 during such irradiation, the x-rays 33 are individually absorbed or attenuated (i.e., weakened) at various differing levels depending on the particular biological tissues existing within the ROI 64. These differing levels of x-ray absorption or attenuation are sensed and detected by an array of x-ray detector elements 63 included within the detector 59 and situated opposite the x-ray tube 20. Based on these differing levels as detected, the CT imaging system 60 is able to generate x-ray strength profiles and therefrom “construct” digital images of the patient's ROI 64 with the help of data-processing computers (not shown). Upon constructing such images, the images may be visibly displayed on a computer monitor (not shown) so that a doctor or other medical professional can indirectly observe and examine the ROI 64 within the patient 56. After conducting such an examination, the doctor can then accurately diagnose a patient's malady and prescribe an appropriate treatment.

To facilitate very fast revolutions of an x-ray tube 20 or system 11 mounted on a CT imaging system's gantry 58 while at the same maintaining overall mechanical and operational stability of the CT imaging system 60 itself, the overall weight of the x-ray system 11 must be reduced so as to minimize any destabilizing g-forces associated with the system 11 during rotation on the gantry 58. As alluded to previously, one ideal way to reduce the overall weight of an x-ray system 11 mounted on a CT system's gantry 58 is to minimize the amount of supplemental pump system equipment on the system 11 that is necessary to evacuate gas or air from the x-ray tube 20, for such pump system equipment is typically quite bulky. To help reduce the necessary amount of pump system equipment on such an x-ray system 11, the ferrofluidic seal system 30 encircling the shaft 31 should ideally be designed so as to reduce the frequency of the bursting of the individual annular ferrofluidic seals 53 (i.e., fluid rings) within the system 30. In this way, the x-ray system's pump system 39 in FIG. 2B need only have the physical capacity for mere infrequent to intermittent pumping instead of very frequent to continuous pumping. To reduce the frequency of individual fluid rings 53 bursting within a ferrofluidic seal system 30, however, the seal system 30 must generally be designed so as to reduce or minimize the pressure loads on the individual fluid rings 53 whenever the seal system 30 experiences a significant difference in pressure between the two regions on opposite sides of the seal system 30.

In view of the above, there is a present need in the art for a multi-stage ferrofluidic seal system that is designed to minimize the gas or pressure loads on its individual annular ferrofluidic seals whenever the seal system experiences a significant difference in pressure between the two regions on opposite sides of the seal system.

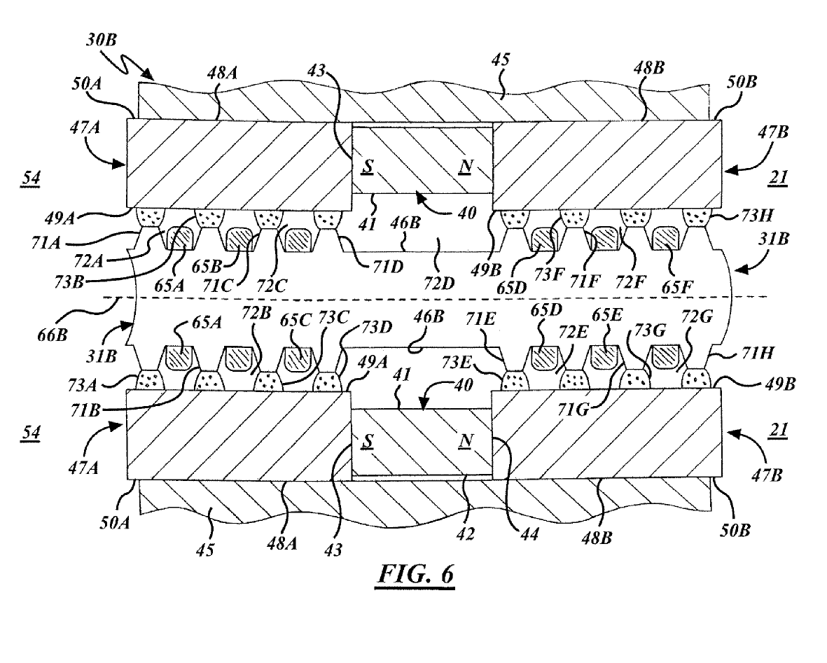

FIG. 6 illustrates a sectional view of one practicable embodiment of a complete multi-stage ferrofluidic seal system 30B according to the present invention. In this view, the ferrofluidic seal system 30B substantially forms a hermetic seal about a rotatable shaft 31B, which extends through an opening in a partition 45 that separates two environments or regions 21 and 54. Though various shapes and materials are possible, the rotatable shaft 31B itself preferably is substantially cylindrical and comprises material that is magnetically permeable. The two regions 21 and 54 may or may not have the same environmental pressures. In one possible scenario, for example, the first region 21 may have an environmental pressure substantially equal to that of a vacuum, and the second region 54 may have an environmental pressure substantially equal to atmospheric pressure or higher.

As shown in FIG. 6, the multi-stage ferrofluidic seal system 30B includes a cylindrical permanent magnet 40, an annular first pole piece 47B, an annular second pole piece 47A, a plurality of annular ridges 71A-71H, a plurality of annular ferrofluidic seals 73A-73H, and a plurality of annuluses 65A-65F. The cylindrical permanent magnet 40, first of all, is substantially hollow and has both a first end 44 with a north-seeking pole N and an opposite second end 43 with a south-seeking pole S. As such, the cylindrical permanent magnet 40 is mounted within the partition opening so as to encircle the shaft 31B. Preferably, the cylindrical permanent magnet 40 encircles the shaft 31B such that the magnet 40 and the shaft 31B are not directly contiguous with each other. In addition thereto, the annular first pole piece 47B is mounted within the partition opening so as to encircle the shaft 31B as well and also substantially abut the first end 44 of the permanent magnet 40. The annular second pole piece 47A, on the other hand, is mounted within the partition opening so as to encircle the shaft 31B and substantially abut the second end 43 of the permanent magnet 40. Moreover, the annular ridges 71A-71H are defined (for example, machined) and spaced apart on the outer surface 46B of the shaft 31B so that the shaft 31B is situated in close proximity with both the first pole piece 47B and the second pole piece 47A by means of the annular ridges 71A-71H. The annular ferrofluidic seals 73A-73H, in turn, are respectively formed on the tops of the annular ridges 71A-71H so as to substantially seal close-proximity gaps between the tops of the annular ridges 71A-71H on the shaft 31B and the inner surfaces 49A and 49B of the two pole pieces 47A and 47B. Furthermore, each of the annuluses 65A-65F is respectively situated in one of the spaces 72A-72G between the annular ridges 71A-71H so as to encircle the shaft 31B and be contiguous therewith. In such a configuration, each annulus 65 generally serves to occupy space 72 within the multi-stage ferrofluidic seal system 30B so as to reduce the gas load therein.

Though the annular ridges 71A-71H are defined and spaced apart on the outer surface 46B of the shaft 31B in the embodiment shown in FIG. 6, it is to be understood that such annular ridges 71 may instead be defined (for example, machined) and spaced apart on one or both of the inner surfaces 49A and 49B of the two annular pole pieces 47A and 47B in alternative embodiments. In such alternative embodiments, the annular ferrofluidic seals 73 are respectively formed on the tops of the annular ridges 71 so as to substantially seal close-proximity gaps between the outer surface 46B of the shaft 31B and the tops of the annular ridges 71 on one or both of the two annular pole pieces 47A and 47B. Also in such alternative embodiments, the annuluses 65 are alternatively sized and respectively situated in the spaces 72 between the annular ridges 71 so that the annuluses 65 are contiguous with one or both of the two annular pole pieces 47A and 47B.

In FIG. 6, each annulus 65 preferably comprises substantially non-magnetic or non-ferromagnetic material(s) such as, for example, stainless steel. Comprising such, each annulus 65 thereby largely avoids interfering with any magnetic field that is generated and established by the permanent magnet 40. In addition, each annulus 65 preferably is substantially solid and is generally not hollow. In this way, each annulus 65 is not prone to release any gas trapped within its own structure (i.e., outgassing) when exposed to external high-pressure loads.

During operation of the ferrofluidic seal system 30B when the regions 21 and 54 have substantially differing environmental pressures, the annuluses 65A-65F generally serve to take up and occupy space in the interstage spaces 72A-72G within the seal system 30B. In doing so, each annulus 65 thereby reduces the potential volume and amount of gas or air that can be trapped within, or passed through, each space 72 should one or more of the individual ferrofluidic seals (i.e., fluid rings) 73 burst. In addition, by reducing the potential volume of gas or air that can occupy each space 72, the annuluses 65 also help ensure that the difference in pressure between any two spaces 72 immediately surrounding a particular ferrofluidic seal 73 is less likely to cause the seal 73 to burst. Ultimately, therefore, by generally including the annuluses 65A-65F in the interstage spaces 72A-72G of the ferrofluidic seal system 30B, minimal amounts of gas or air are apt to be passed completely through the seal system 30B over time. As a result, any pump system that may be needed to help evacuate a vacuum-based system associated with such a ferrofluidic seal system 30B need only have the physical capacity for mere infrequent to intermittent pumping instead of very frequent to continuous pumping. Furthermore, by so minimizing the overall gas load on the ferrofluidic seal system 30B in the above-described manner, the operational life of the seal system 30B, as well as the useful life of any vacuum-based system associated therewith, is likely to be extended.

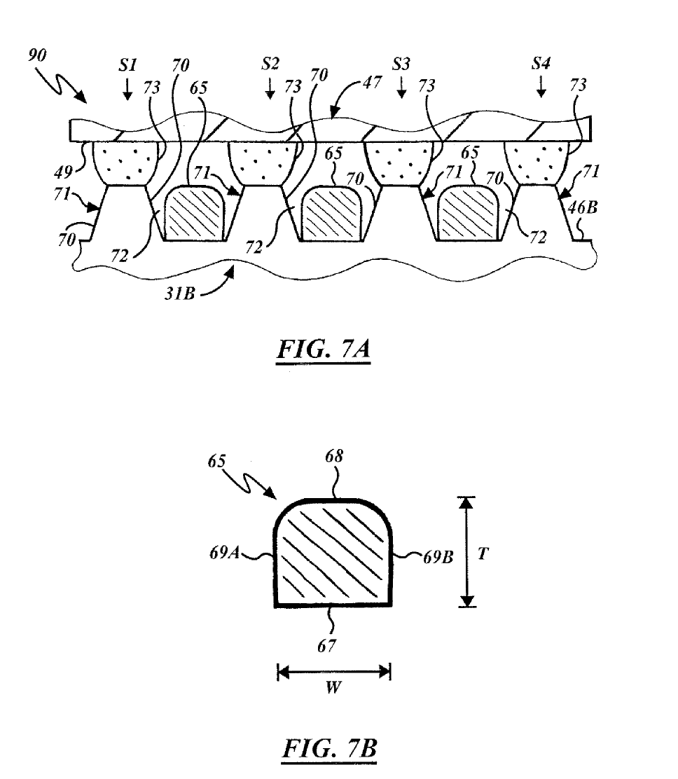

FIG. 7A illustrates a sectional view of one practicable embodiment of a simple multi-stage ferrofluidic seal 90 according to the present invention. In this view, the ferrofluidic seal 90 substantially forms a hermetic seal about a rotatable shaft 31B that extends through an annular pole piece 47. As shown in FIG. 7A, the multi-stage ferrofluidic seal 90 includes a plurality of annular ridges 71, a plurality of annular ferrofluidic seals 73, and a plurality of annuluses 65. The annular ridges 71, first of all, are defined and spaced apart on the outer surface 46B of the shaft 31B so that the shaft 31B is situated in close proximity with the pole piece 47 by means of the annular ridges 71. The annular ferrofluidic seals 73, in turn, are respectively formed on the tops of the annular ridges 71 so as to substantially seal close-proximity gaps between the tops of the annular ridges 71 on the shaft 31B and the inner surface 49 of the pole piece 47. Furthermore, each of the annuluses 65 is respectively situated in one of the spaces 72 between the annular ridges 71 so as to encircle the shaft 31B and be contiguous therewith. In such a configuration, each annulus 65 generally serves to occupy space 72 within the multi-stage ferrofluidic seal 90 so as to reduce the gas load therein.

In FIG. 7A, though the annular ridges 71 are defined and spaced apart on the outer surface 46B of the shaft 31B in the embodiment shown therein, it is to be understood that such annular ridges 71 may instead be defined and spaced apart on the inner surface 49 of the annular pole piece 47 in alternative embodiments. In such alternative embodiments, the annular ferrofluidic seals 73 are respectively formed on the tops of the annular ridges 71 so as to substantially seal close-proximity gaps between the outer surface 46B of the shaft 31B and the tops of the annular ridges 71 on the annular pole piece 47. Also in such alternative embodiments, the annuluses 65 are respectively situated in the spaces 72 between the annular ridges 71 so that the annuluses 65 are contiguous with the annular pole piece 47.

As best shown in FIG. 7A, the annular ridges 71 included within the simple multi-stage ferrofluidic seal 90, as well as within the complete multi-stage ferrofluidic seal system 30B of FIG. 6, preferably have sidewalls 70 that are sloped. In having such sloped sidewalls 70, the ridges 71 are thereby tapered toward their tops and are thus generally better able to facilitate tight formation of the individual ferrofluidic seals 73 thereon. In addition thereto, the tapered tops of the ridges 71 also help prevent the annuluses 65 from coming into contact with the ferrofluidic seals 73 and interfering with the seals' formation.

Furthermore, as best shown in FIG. 7B, each annulus 65 included within the multi-stage ferrofluidic seal 90 of FIG. 7A, as well as within the multi-stage ferrofluidic seal system 30B of FIG. 6, has a sectional profile that is contoured, or partially rounded, to further help prevent each annulus 65 from coming into contact with one of the ferrofluidic seals 73. In this way, as alluded to previously, each annulus 65 is largely prevented from interfering with a nearby seal's formation or reformation. To even further help prevent the annuluses 65 from coming into contact with the ferrofluidic seals 73, each annulus 65 has a sectional profile with a thickness T that generally does not exceed the respective heights of ridges 71 situated nearby. However, to best help maximize the capacity of each annulus 65 to occupy space within the multi-stage ferrofluidic seal 90 while at the same time prevent each annulus 65 from coming into contact with a ferrofluidic seal 73, each annulus 65 preferably has a sectional thickness T that is substantially commensurate with the respective heights of the ridges 71 situated nearby. In addition, with regard to the respective widths of the annuluses 65, each annulus 65 preferably has a sectional width W that is substantially commensurate with the lateral distance between the respective facing sidewalls 70 of the two ridges 71 situated immediately alongside the two side surfaces 69A and 69B of the annulus 65.

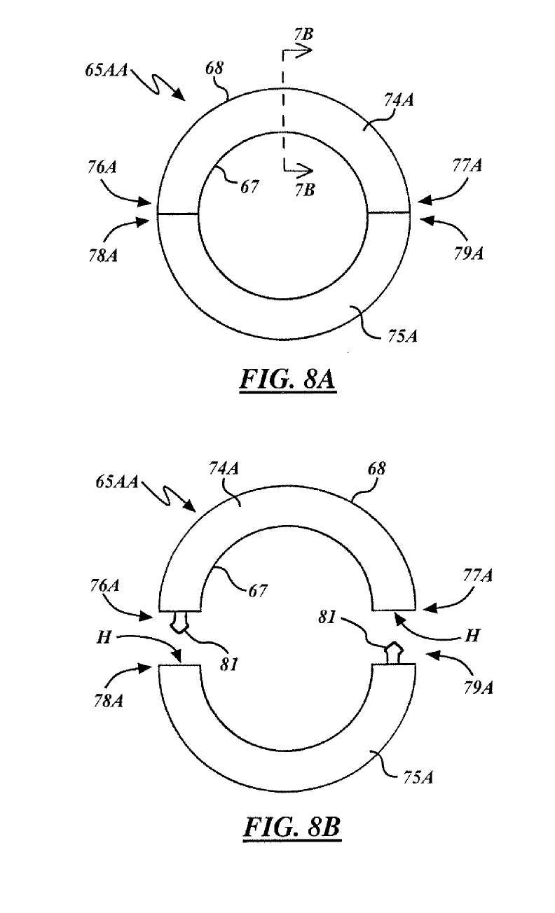

FIGS. 8A and 8B illustrate plan views of one practicable embodiment of an annulus assembly 65AA. In FIG. 8A, the annulus assembly 65AA is shown fully assembled. In FIG. 8B, the annulus assembly 65AA is alternatively shown disassembled. In general, the annulus assembly 65AA is suitable for serving as an annulus 65 within either the multi-stage ferrofluidic seal 90 of FIG. 7A or the multi-stage ferrofluidic seal system 30B of FIG. 6.

As shown in FIGS. 8A and 8B, the annulus assembly 65AA includes a substantially semicircular first arcuate section 74A, a substantially semicircular second arcuate section 75A, a fully releasable first connector, and a fully releasable second connector. The first arcuate section 74A has a first end 76A and a second end 77A, and the second arcuate section 75A has a first end 79A and a second end 78A as well. The first connector includes both a small catch pin (i.e., a male connector) 81 and a small catch hole (i.e., a female connector) H that are adapted for releasably connecting the first end 76A of the first arcuate section 74A to the second end 78A of the second arcuate section 75A. The second connector similarly includes both a male connector 81 and a female connector H and is adapted for releasably connecting the second end 77A of the first arcuate section 74A to the first end 79A of the second arcuate section 75A. Adapted as such, the first connector and the second connector are utile for connecting (i.e., snapping) the first arcuate section 74A and the second arcuate section 75A together so that the first arcuate section 74A and the second arcuate section 75A are able to cooperatively encircle the rotatable shaft 31B.

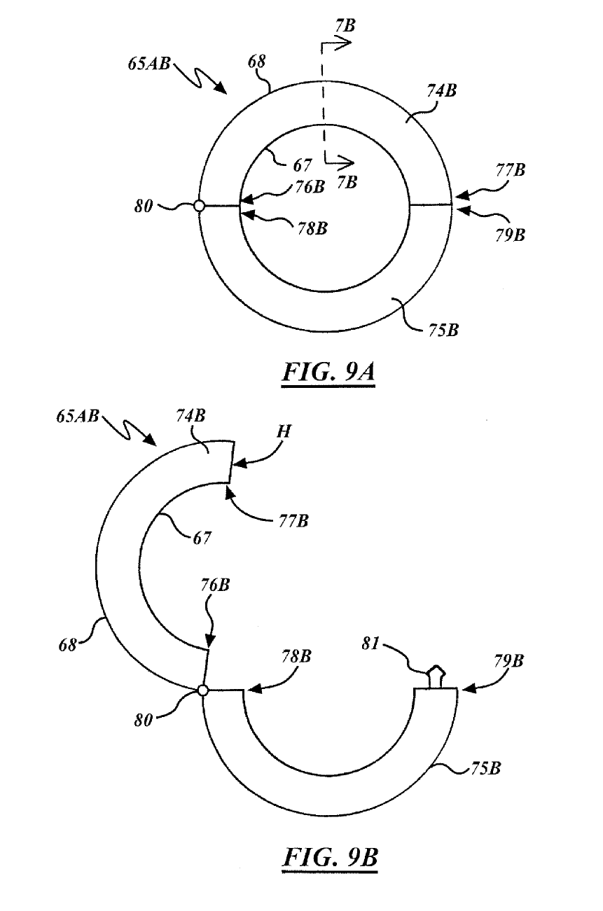

FIGS. 9A and 9B illustrate plan views of another practicable embodiment of an annulus assembly 65AB. In FIG. 9A, the annulus assembly 65AB is shown fully assembled. In FIG. 9B, the annulus assembly 65AB is alternatively shown disassembled. As is the annulus assembly 65AA, the annulus assembly 65AB too is suitable for serving as an annulus 65 within either the multi-stage ferrofluidic seal 90 of FIG. 7A or the multi-stage ferrofluidic seal system 30B of FIG. 6. In general, the annulus assembly 65AB is quite similar to the annulus assembly 65AA, except that the assembly 65AB has the first end 76B of its first arcuate section 74B pivotally connected to the second end 78B of its second arcuate section 75B with a hinge connector 80.

Though the annulus assembly 65AA in FIGS. 8A and 8B and also the annulus assembly 65AB in FIGS. 9A and 9B are shown to largely comprise two arcuate sections 74 and 75, it is to be understood that an annulus or annulus assembly 65 pursuant to the present invention may comprise any number of sections or parts, and such parts may be connected together by any known conventional means. Furthermore, an annulus 65 pursuant to the present invention may even comprise a single monolithic o-shaped part, though such may be somewhat difficult to properly install about a shaft 31.

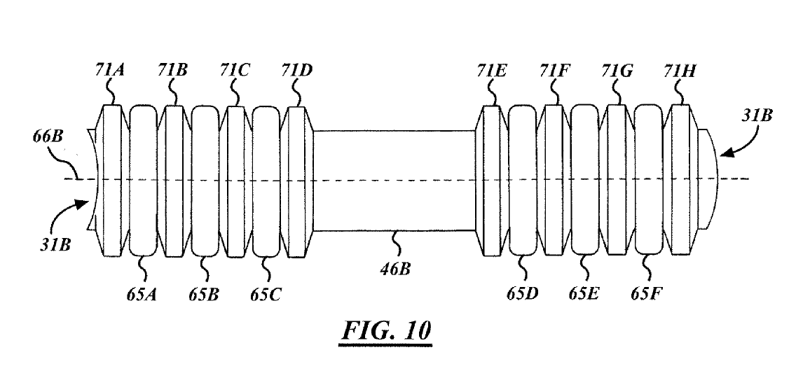

For purposes of further illustration, FIG. 10 shows a longitudinal view of the rotatable shaft 31B and the annuluses or annulus assemblies 65A-65F depicted in FIG. 6. In this view, the shaft 31B is shown to include the annular ridges 71A-71H that are defined and spaced apart on the outer surface 46B of the shaft 31B. Also in this view, the annuluses or annulus assemblies 65A-65F are shown situated between the annular ridges 71A-71H so as to encircle the shaft 31B at various points along its length.

Lastly, for purposes of interpreting and defining the scope of the present invention, the word “annulus” as used herein is intended to read on any part, member, or structure, whether monolithic or assembled, that is substantially annular, circinate, circular, c-shaped, doughnut-shaped, ellipsoidal, elliptical, grommet-shaped, o-shaped, oval, penannular (i.e., almost annular), ring-like, ring-shaped, toroidal, or torus-shaped, or that generally surrounds a shaft.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. A multi-stage ferrofluidic seal system for substantially forming a hermetic seal about a rotatable shaft extending through an opening in a partition between a first region and a second region, said multi-stage ferrofluidic seal system comprising:
a hollow cylindrical permanent magnet, mounted within said partition opening so as to encircle said shaft, having both a first end with a north-seeking pole and an opposite second end with a south-seeking pole;
an annular first pole piece mounted within said partition opening so as to encircle said shaft and substantially abut said first end of said permanent magnet;
an annular second pole piece mounted within said partition opening so as to encircle said shaft and substantially abut said second end of said permanent magnet;
a plurality of annular ridges defined and spaced apart on at least one of the outer surface of said shaft, the inner surface of said first pole piece, and the inner surface of said second pole piece so that said shaft is situated in close proximity with at least one of said first pole piece and said second pole piece by means of said annular ridges;
a plurality of annular ferrofluidic seals respectively formed on the tops of said annular ridges so as to substantially seal close-proximity gaps between said shaft and at least one of said first pole piece and said second pole piece; and
at least one annulus respectively situated in at least one of the spaces between said annular ridges so as to encircle said shaft;
wherein each said annulus serves to occupy space within said multi-stage ferrofluidic seal system so as to reduce the gas load therein.

2. A multi-stage ferrofluidic seal system according to claim 1, wherein said rotatable shaft is substantially cylindrical and comprises material that is magnetically permeable.

3. A multi-stage ferrofluidic seal system according to claim 1, wherein said first region has an environmental pressure substantially equal to that of a vacuum, and said second region has an environmental pressure substantially equal to atmospheric pressure.

4. A multi-stage ferrofluidic seal system according to claim 1, wherein said hollow cylindrical permanent magnet encircles said shaft such that said magnet and said shaft are non-contiguous with each other.

5. A multi-stage ferrofluidic seal system according to claim 1, wherein each of said ridges is tapered toward its top.

6. A multi-stage ferrofluidic seal system according to claim 1, wherein:
said plurality of annular ridges are defined and spaced apart particularly on said outer surface of said shaft;
said plurality of annular ferrofluidic seals are respectively formed on said tops of said annular ridges so as to substantially seal close-proximity gaps particularly between said tops of said annular ridges on said shaft and the inner surface of at least one of said first pole piece and said second pole piece; and
each said annulus is respectively situated in one of said spaces between said annular ridges so that each said annulus is particularly contiguous with said shaft.

7. A multi-stage ferrofluidic seal system according to claim 1, wherein:
said plurality of annular ridges are defined and spaced apart particularly on the inner surface of at least one said first pole piece and said second pole piece;
said plurality of annular ferrofluidic seals are respectively formed on said tops of said annular ridges so as to substantially seal close-proximity gaps particularly between said outer surface of said shaft and said tops of said annular ridges on at least one of said first pole piece and said second pole piece; and
each said annulus is respectively situated in one of said spaces between said annular ridges so that each said annulus is particularly contiguous with at least one of said first pole piece and said second pole piece.

8. A multi-stage ferrofluidic seal system according to claim 1, wherein each said annulus is substantially solid.

9. A multi-stage ferrofluidic seal system according to claim 1, wherein each said annulus comprises non-magnetic material.

10. A multi-stage ferrofluidic seal system according to claim 1, wherein each said annulus has a sectional profile that is contoured so as to be non-contiguous with said ferrofluidic seals.

11. A multi-stage ferrofluidic seal system according to claim 1, wherein each said annulus has a sectional thickness that is substantially commensurate with the respective heights of said annular ridges.

12. A multi-stage ferrofluidic seal for substantially forming a hermetic seal about a rotatable shaft extending through an annular pole piece, said multi-stage ferrofluidic seal comprising:
a plurality of annular ridges defined and spaced apart on at least one of the outer surface of said shaft and the inner surface of said pole piece so that said shaft is situated in close proximity with said pole piece by means of said annular ridges;
a plurality of annular ferrofluidic seals respectively formed on the tops of said annular ridges so as to substantially seal close-proximity gaps between said shaft and said pole piece; and
at least one annulus respectively situated in at least one of the spaces between said annular ridges so as to encircle said shaft;
wherein each said annulus serves to occupy space within said multi-stage ferrofluidic seal so as to reduce the gas load therein.

13. An annulus assembly for occupying interstage space and thereby reducing the gas load within a multi-stage ferrofluidic seal that substantially forms a hermetic seal about a rotatable shaft, said annulus assembly comprising:
a first arcuate section having a first end and a second end;
a second arcuate section having a first end and a second end;
a first connector for connecting said first end of said first arcuate section to said second end of said second arcuate section; and
a second connector for connecting said second end of said first arcuate section to said first end of said second arcuate section;
wherein said first connector and said second connector are utile for connecting said first arcuate section and said second arcuate section together so that said first arcuate section and said second arcuate section cooperatively encircle said rotatable shaft.

14. An annulus assembly according to claim 13, wherein each of said first arcuate section and said second arcuate section is substantially solid.

15. An annulus assembly according to claim 13, wherein each of said first arcuate section and said second arcuate section comprises non-magnetic material.

16. An annulus assembly according to claim 13, wherein each of said first arcuate section and said second arcuate section consists essentially of non-magnetic material.

17. An annulus assembly according to claim 13, wherein each of said first arcuate section and said second arcuate section has an overall shape that substantially resembles a semicircle.

18. An annulus assembly according to claim 13, wherein each of said first arcuate section and said second arcuate section has a sectional profile that is at least partially rounded.

19. An annulus assembly according to claim 13, wherein at least one of said first connector and said second connector is fully releasable.

20. An annulus assembly according to claim 13, wherein one of said first connector and said second connector comprises a hinge.
